(19) United States
(12) Patent Application Publication
(10) Pub. No.: US 2018/0155129 A1
(43) Pub. Date: Jun. 7, 2018

(54) SYSTEM FOR MANAGEMENT OF PACKING

(71) Applicant: ISRAEL AEROSPACE INDUSTRIES LTD., Lod (IL)

(72) Inventors: Rafi Lagziel, Modi'in (IL); Itzhak Kiselevish, Rishon LeZion (IL)

(21) Appl. No.: 15/889,989

(22) Filed: Feb. 6, 2018

Related U.S. Application Data
(63) Continuation-in-part of application No. PCT/IL2016/050860, filed on Aug. 7, 2016.

(30) Foreign Application Priority Data
Aug. 9, 2015 (IL) 240426
Feb. 10, 2016 (IL) 244096

(51) Int. Cl. B65G 1/137; B25J 15/06; B25J 5/02; B25J 9/16; G06Q 10/08

(52) U.S. Cl. CPC B65G 1/1373; B65G 1/1371; B25J 15/0641; B25J 5/02; Y10S 901/47; B25J 9/1697; G06Q 10/083; Y10S 901/09; Y10S 901/40; B25J 9/1687

(57) ABSTRACT

A system for management of packing articles on one or more cargo units, each for loading on one of a plurality of cargo vehicles, is provided. The system comprises a registration station to identify and communicate freight data characterizing each of the articles, thereby facilitating registration thereof, wherein the freight data comprises physical attributes and shipping information, and wherein the registration station comprises one or more computer-controlled sensors to identify at least some of the physical attributes; a build-up station configured for packing the articles on the cargo units, the build-up station comprising a robotic arm for carrying an article while supporting it from below; and a controller to receive the freight data from the registration station, and to direct operation of the system.

### CROSS-REFERENCE TO RELATED APPLICATIONS

The present application is a continuation-in-part of PCT International Application No. PCT/IL2016/050860 filed on Aug. 7, 2016, which claims priority to Israel Patent Application No. IL 240426 filed on Aug. 9, 2015 and Israel Patent Application No. IL 244096 filed on Feb. 10, 2016, the contents of each of the foregoing applications are incorporated herein, in their entirety, by this reference.

### TECHNOLOGICAL FIELD

The presently disclosed subject matter relates to systems management of arranging and packing articles in cargo units for shipment on cargo vehicles.

### BACKGROUND

Articles shipped long distances are often shipped in bulk from an origin logistics center to a destination logistics center, from where they are delivered to their final destinations or forwarded to a further depot. For the shipping, they are often loaded onto cargo units (such as pallets and/or containers) which are loaded onto a cargo vehicle for shipping. Typically, articles arrive at the logistics center at times which are not coordinated with the departure times of cargo vehicles therefrom. Thus, the logistics center may include a storage facility for temporarily storing articles which have arrived, but which are not scheduled to be packed into cargo units for some time.

### SUMMARY

According to one aspect of the presently disclosed subject matter, there is provided a system for management of packing articles on one or more cargo units, each for loading on one of a plurality of cargo vehicles, the system comprising:
a registration station to identify and communicate freight data characterizing each of the articles, thereby facilitating registration thereof, wherein the freight data comprises physical attributes and shipping information, and wherein the registration station comprises one or more computer-controlled sensors to identify at least some of the physical attributes;
a build-up station configured for packing the articles on the cargo units, the build-up station comprising a robotic arm with a grip having a support platform configured for supporting one of the articles from below, and a vacuum array configured to pull the article onto the support platform by imparting a negative pressure thereto, and to push the article off of the support platform; and
a controller to receive the freight data from the registration station, and to direct operation of the system;
   wherein the controller is configured to perform a packing optimization comprising:
associating each registered article with a target cargo vehicle, based at least on the shipping information;
determining an optimized arrangement of articles, based at least on the physical attributes thereof, assigned to a single target cargo vehicle, within the one or more cargo units; and
determining, based on the associated target cargo vehicle associated with each registered article, an optimized intermediate arrangement for storage, between registration of articles and packing thereof on the cargo unit, of a plurality of articles associated with different cargo vehicles, wherein the determination of the intermediate arrangement is optimized to increase the efficiency of removal therefrom of articles associated with a single cargo vehicle;
   wherein the controller is configured to repeat the packing optimization upon registration of a new article.

Each of the cargo vehicles may define a finite number of combinations of cargo unit types for loading thereupon, the packing optimization further comprising selecting a shipping group for loading on the target cargo vehicle, the shipping group comprising the one or more cargo units being a subset of one of the combinations.

The selection of a shipping group may be at least partially based on the optimized arrangement of articles.

The controller may be configured to issue instructions related to transporting all registered articles associated with at least one cargo unit of a shipping group to a predetermined location for the packing.

The controller may be configured to issue instructions related to one or more of:
transporting one or more registered articles for storage according to the intermediate arrangement; and
packing one or more cargo units of a shipping group according to the optimized arrangement.

At least some of the instructions may comprise commands for directing operation of an autonomous guided vehicle.

At least some of the instructions may comprise commands for directing operation of an autonomous robotic arm.

At least some of the instructions comprise directions for a human.

The controller may be configured to consider, in performing the packing optimization, at least some of:
physical attributes of each article;
shipping information of each article;
dimensional capacity of each cargo unit; and
weight capacity of each cargo unit.

The controller may be further configured to consider, in performing the packing optimization, operational constraints.

The controller may be configured to determine an optimized arrangement of cargo units, packed as per the optimized arrangement of articles, on the cargo vehicle.

The controller may be configured to simultaneously determine the optimized arrangement of articles within each cargo unit and the optimized arrangement of the cargo units on the cargo vehicle.

The controller may be configured to determine the intermediate arrangement further based on a time schedule related to the loading of the target cargo vehicle.

The intermediate arrangement may comprise storage of registered articles within a plurality of compartments.

The controller may be further configured to repeat the packing optimization based on an article registered after the packing has commenced.

The controller may be configured, during the packing optimization, to determine the time required to remove one or more packed articles from its cargo unit.

The system may be configured to register a compound article being characterized by aggregate freight data and comprising a plurality of articles bundled together, each being independently characterized by individual freight data, wherein the controller is configured to selectively perform the packing optimization based on one of the aggregate and individual freight data.

The physical attributes may comprise one or more selected from the group including dimensions, weight, and shape.

The shipping information may comprise one or more selected from the group including destination, priority, and special instructions.

The computer-controlled sensors may comprise a linear motion scanner system.

The computer-controlled sensors may comprise a weight sensor.

The registration station may be configured to identify the shipping information encoded within a computer-detectable signal.

The registration station may be configured to identify the shipping information presented on the article in machine-readable form.

The registration station may be configured to receive the shipping information via a handheld scanner.

The grip may further comprise a linear actuator configured to move the vacuum array over the support platform and longitudinally along its length.

The vacuum array may comprise a plurality of nozzles configure to be connected to a negative pressure source.

At least some of the nozzles may be configured to be selectively activated to apply a negative pressure. At least some of the nozzles may be associated with a sensor configured to detect the presence of the article abutting thereagainst, and a valve configured to open, thereby activating the nozzle, when the sensor detects the article.

The nozzles may be are mounted on one or more panels.

The grip may further comprise a face plate retaining the panels.

The panels may be pivotable. The grip may be configured to move the panels vertically.

The vacuum array may be connected to a linear actuator configured to move it along the support platform.

The linear actuator may comprise one or more of:
a scissors mechanism comprising a plurality of folding links;
one or more pistons; and
a lead screw.

The support platform may comprise a tapered leading edge.

At least a portion of an upper surface of the support platform may comprise one or more rollers.

At least a portion of an upper surface of the support platform may be provided with a low-friction coating.

The packing optimization may further comprise selecting, from a predetermined list of available vehicles, a target cargo vehicle for being associated with a plurality of registered articles. The controller may be further configured to simultaneously select a target vehicle, determine an optimized arrangement of cargo units thereon, and determine a optimized arrangement of articles within each of the cargo units.

According to another aspect of the presently disclosed subject matter, there is provided a system for management of packing articles on one or more cargo units, each for loading on one of a plurality of cargo vehicles, the system comprising:
a registration station to identify and communicate freight data characterizing each of the articles, thereby facilitating registration thereof, wherein the freight data comprises physical attributes and shipping information, and wherein the registration station comprises one or more computer-controlled sensors to identify at least some of the physical attributes;
a build-up station configured for packing the articles on the cargo units, the build-up station comprising a robotic arm for carrying an article while supporting it from below; and
a controller to receive the freight data from the registration station, and to direct operation of the system;
   wherein the controller is configured to perform a packing optimization comprising:
associating each registered article with a target cargo vehicle, based at least on the shipping information;
determining an optimized arrangement of articles, based at least on the physical attributes thereof, assigned to a single target cargo vehicle, within the one or more cargo units; and
determining, based on the associated target cargo vehicle associated with each registered article, an optimized intermediate arrangement for storage, between registration of articles and packing thereof on the cargo unit, of a plurality of articles associated with different cargo vehicles, wherein the determination of the intermediate arrangement is optimized to increase the efficiency of removal therefrom of articles associated with a single cargo vehicle;
   wherein the controller is configured to repeat the packing optimization upon registration of a new article.

According to another aspect of the presently disclosed subject matter, there is provided a system for management of packing articles on one or more cargo units, each for loading on one of a plurality of cargo vehicles, the system comprising:
a registration station to identify and communicate freight data characterizing each of the articles, thereby facilitating registration thereof, wherein the freight data comprises physical attributes and shipping information, and wherein the registration station comprises one or more computer-controlled sensors to identify at least some of the physical attributes;
a build-up station configured for packing the articles on the cargo units, the build-up station comprising a robotic arm for carrying an article while supporting it from below; and
a controller to receive the freight data from the registration station, and to direct operation of the system.

The physical attributes may comprise one or more selected from the group including dimensions, weight, and shape.

The shipping information may comprise one or more selected from the group including destination, priority, and special instructions.

The computer-controlled sensors may comprise a linear motion scanner system.

The computer-controlled sensors may comprise a weight sensor.

The registration station may be configured to identify the shipping information encoded within a computer-detectable signal.

The registration station may be configured to identify the shipping information presented on the article in machine-readable form.

The registration station may be configured to receive the shipping information via a handheld scanner.

The robotic arm may comprise a support platform for supporting the article, and a vacuum array configured to move the article onto the support platform by imparting a negative pressure thereto.

The robotic arm may further comprise a linear actuator configured to move the vacuum array over the support platform and longitudinally along its length.

According to a further aspect of the presently disclosed subject matter, there is provided a controller for directing operation of a system for management of packing a plurality of articles, each being characterized by freight data comprising physical attributes and shipping information, on one or more cargo units, each for loading on one of a plurality of cargo vehicles, the controller being configured to register an article upon receipt of freight information thereof, and to perform a packing optimization comprising:
associating each registered article with a target cargo vehicle, based at least on the shipping information;
determining an optimized arrangement of articles, based at least on the physical attributes thereof, assigned to a single target cargo vehicle, within the one or more cargo units; and
determining, based on the associated target cargo vehicle associated with each registered article, an optimized intermediate arrangement for storage, between registration of articles and packing thereof on the cargo unit, of a plurality of articles associated with different cargo vehicles, wherein the determination of the intermediate arrangement is optimized to increase the efficiency of removal therefrom of articles associated with a single cargo vehicle;
   wherein the controller is configured to repeat the packing optimization upon registration of each article.

According to a still further aspect of the presently disclosed subject matter, there is provided a robotic arm for carrying an article while supporting it from below.

The robotic may comprise a support platform for supporting the article, and a vacuum array configured to move the article onto the support platform by imparting a negative pressure thereto, and to push the article off of the support platform.

The robotic may further comprises a linear actuator configured to move the vacuum array over the support platform and longitudinally along its length.

The robotic arm may be configured to operate autonomously. It may be configured to be manually operated.

The robotic arm may be further characterized, alone or a component of a system, by any one or more features of the robotic arm described herein below.

According to a further aspect of the presently disclosed subject matter, there is provided a grip comprising a support platform configured for supporting an article from below, and a vacuum array configured to pull the article onto the support platform by imparting a negative pressure thereto, and to push the article off of the support platform.

The grip may further comprise a linear actuator configured to move the vacuum array over the support platform and longitudinally along its length.

The vacuum array may comprise a plurality of nozzles configure to be connected to a negative pressure source.

At least some of the nozzles may be configured to be selectively activated to apply a negative pressure. At least some of the nozzles may be associated with a sensor configured to detect the presence of the article abutting thereagainst, and a valve configured to open, thereby activating the nozzle, when the sensor detects the article.

The nozzles may be are mounted on one or more panels.

The grip may further comprise a face plate retaining the panels.

The panels may be pivotable. The grip may be configured to move the panels vertically.

The vacuum array may be connected to a linear actuator configured to move it along the support platform.

The linear actuator may comprise one or more of:
a scissors mechanism comprising a plurality of folding links;
one or more pistons; and
a lead screw.

The support platform may comprise a tapered leading edge.

At least a portion of an upper surface of the support platform may comprise one or more rollers.

At least a portion of an upper surface of the support platform may be provided with a low-friction coating.

According to a further aspect of the presently disclosed subject matter, there is provided a grip for carrying an article while supporting it from below. The grip may be provided according to the above aspect of the presently disclosed subject matter.

According further aspects of the presently disclosed subject matter, there are provided a robotic arm and a lift truck, each comprising a grip as described above.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a schematic illustration of a system according to the presently disclosed subject matter;

FIG. 2 is a perspective view of a registration station of the system illustrated in FIG. 1;

FIG. 3 is a perspective view of a build-up station of the system illustrated in FIG. 1;

FIG. 4 is a close-up view of a packing mechanism of a packing rig of the build-up station illustrated in FIG. 3;

FIG. 5 is a close-up view of an example of a grip of the packing mechanism illustrated in FIG. 4;

FIGS. 6A and 6B are front and rear perspective view, respectively, of another example of a grip of the packing mechanism illustrated in FIG. 4;

FIG. 7 is a perspective view of a lift truck comprising a grip as illustrated in FIGS. 6A and 6B; and

FIG. 8 is a perspective view of a storage facility for use with the system illustrated in FIG. 1.

### DETAILED DESCRIPTION OF EMBODIMENTS

As illustrated in FIG. 1, there is provided a system, which is generally indicated at 10, for management of packing articles (i.e., managing the packing of articles) on cargo units, each of which is to be loaded on one of a plurality of cargo vehicles. Such a system 10 may be designed for use, for example, in an airport cargo terminal or seaport logistics center, where a shipping company receives a large number of articles (e.g., packages, envelopes, boxes, etc.), which are to be shipped to different destinations on different cargo vehicles. (Hereafter, the term “site” will be used to refer to any location at which the system is deployed for use.) Before being placed on the cargo vehicles, articles are organized on cargo units which are then loaded onto an appropriate cargo vehicle, e.g., for transport to a logistics center in the vicinity, as determined by the shipping company, near or on route to the destination.

Herein the specification and claims, the term “article” is used, unless specified or clear from context to the contrary, to refer to an individual item being shipped from an origin to a final destination. Each article is characterized by certain properties (such as physical attributes, shipping information, etc.), at least some of which the system 10 may take into account during operation.

In addition, herein the specification and claims, the term “compound article” is used to refer to a single article which comprises a plurality of individual articles (hereafter, “constituent articles”), as per the above, and is typically bundled together, for example by wrapping, packing, etc. The compound article is characterized by aggregate properties (e.g., overall physical attributes). Each of the articles bundled therein is characterized by individual properties (e.g., the physical attributes of each article). The shipping information of each article may be the same as that of the aggregate properties of the compound article. The shipping company may determine that aggregate articles are to be transported in their bundled state, or unbundled, for example if the space within the cargo units and/or cargo vehicles can be thereby utilized more efficiently. It will be appreciated that any reference herein to an “article” includes, mutatis mutandis, a compound article as well, except where explicitly noted or clear from context to the contrary.

In addition, herein the specification and claims, the term “cargo unit” is used to refer to an arrangement by which (typically, but not always) a plurality of articles is packed before being loaded onto a cargo vehicle for shipment. Examples of cargo units may include, but are not limited to, pallets, containers, bins, etc. Each cargo unit defines physical limitation on the arrangement of articles therewithin. The limitations may include, but are not limited to, those dictated by dimensional (i.e., the arrangement of articles may not exceed a certain height, width, and/or depth) and weight capacities.

It will be appreciated that while herein the articles will be described as being loaded “on” a cargo unit, this is done for simplification of the disclosure only, and should not be construed as limiting to type of cargo units which articles may be loaded on (e.g., it should not be construed that loading on a cargo unit excludes a container, which may be more properly described as having articles loaded therein.

In addition, herein the specification and claims, the term “cargo vehicle” is a vehicle which is used for transporting loaded cargo units. In particular, it is used to refer to the departure of a loaded vehicle from the site, not to the physical vehicle itself (i.e., a vehicle which is to be loaded, depart the site, and return empty for further loading, is considered for the purposes of this disclosure as two distinct cargo vehicles). Examples of cargo vehicles may include, but are not limited to, airplanes, ships, trucks, carts, etc. Each cargo vehicle defines one or more combinations of cargo units which may be loaded thereon for transport.

The system 10 comprises one or more registration stations 12, configured for registration of articles 14 into the system by identifying properties thereof (for example, upon arrival at the site), and one or more build-up stations 16, configured for packing articles onto cargo units prior to being loaded onto cargo vehicles. The system further comprises a processor, indicated at 18, configured to direct operation thereof.

It will be appreciated that while herein the specification and claims, the term “controller” is used as if in reference to a single element, it may comprise a combination of elements, which may or may not be in physical proximity to one another, without departing from the scope of the presently disclosed subject matter, mutatis mutandis. In addition, disclosure herein (including recitation in the appended claims) of a controller carrying out, being configured to carry out, or other similar language, implicitly includes other elements of the system 10 carrying out, being configured to carry out, etc., those functions, without departing from the scope of the presently disclosed subject matter, mutatis mutandis.

Furthermore, the term “controller” as used herein should be expansively construed to cover any kind of electronic device with data processing capabilities, including, but not limited to, a personal computer, a server, a computing system, a communication device, a processor (e.g., digital signal processor, a microcontroller, a field programmable gate array, an application specific integrated circuit ASIC, etc., or any combination thereof), any other electronic computing device, and/or any combination thereof.

In addition, the system 10 may comprise a plurality of autonomous vehicles 20 for moving articles between different locations at the site, which may be forklifts. According to some examples, the autonomous vehicles 20 are provided independently from the system 10 (i.e., the system does not comprise the autonomous vehicles 20), whereby the system is configured to communicate with them, for example using one or more wireless transmitters (not illustrated).

The site may include one or more storage facilities 22, which the system 10 may utilize for temporary storage of articles 14 between registration thereof at one of the registration stations 12, and packing thereof onto cargo units at one of the buildup stations 16. It will be appreciated that several facilities located separate from each other within the site may be considered as a single storage facility 22, for example for the purposes of one or more of the optimizations described below.

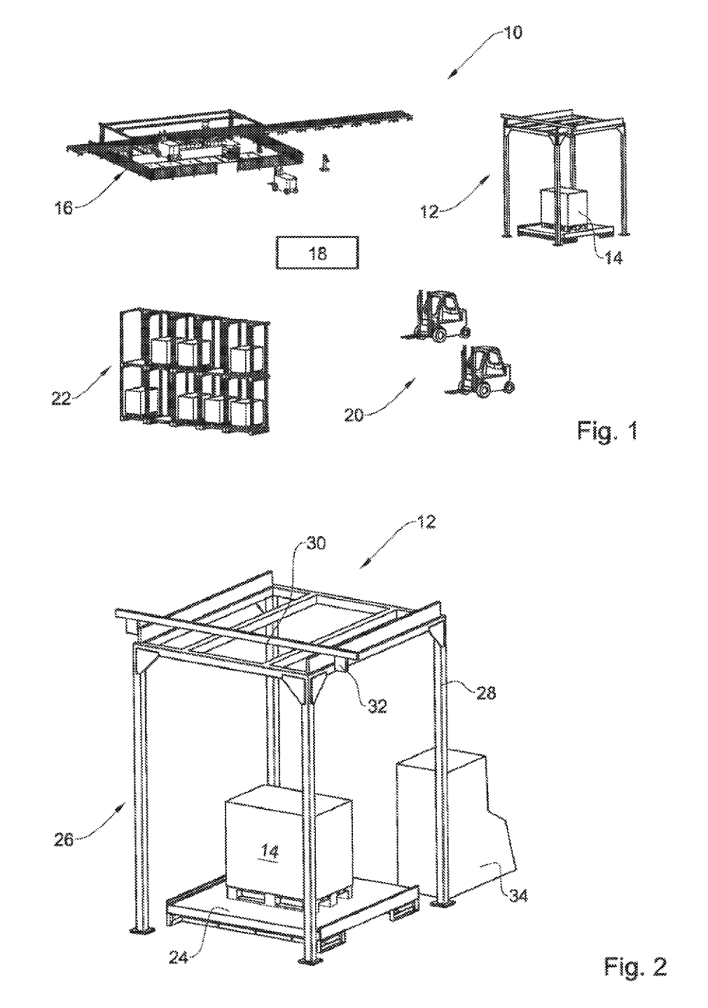

As mentioned above, the registration station 12 is configured for identifying properties of articles for entry into the system 10. Accordingly, it is typically the located in close proximity and/or with convenient access to entry points for articles delivered to the site. As illustrated in FIG. 2, the registration station 12 comprises a weight sensor 24 and a linear dimensioning arrangement 26 for measuring physical attributes of each article 14.

The weight sensor 24 may be any suitable device configured to determine the weight of an object placed thereupon, e.g., being at least partially computer-controlled. It may be configured to display the measured weight to an operator who manually enters it into a computer terminal 34 (described below) for communication to the controller 18. Alternatively, it may be configured to communicate the measured weight directly to the controller 18.

The linear dimensioning arrangement 26 may be any suitable arrangement e.g., being at least partially computer-controlled, for determining the linear dimensions of an article 14. For example, it may comprise a linear motion scanner system having a dimensioning frame 28 providing a space therewithin for the article, a scanner carrier 30 configured to move therealong, e.g., the top of the dimensioning frame, and scanners 32 mounted on the scanner carrier and configured, either each alone or together, to measure the linear dimensions of an article 14 placed in the space within the dimensioning frame.

In addition to the dimensions of the article 14, the linear dimensioning arrangement 26 may be further configured to determine its shape, for example if it is not rectangular. It will be appreciated that any reference herein to “dimensions” of an article includes, mutatis mutandis, its shape as well, except where explicitly noted or clear from context to the contrary.

The linear dimensioning arrangement 26 may be configured to display the measured dimensions to an operator who manually enters it into a computer terminal 34 (described below) for communication to the controller 18. Alternatively, it may be configured to communicate the measured dimensions directly to the controller 18.

As illustrated, the weight sensor 24 may be located in the space within the dimensioning frame 28, thereby facilitating measurement of both the weight and dimensions of an article 14 simultaneously.

The registration station 12 may be further configured to identify shipping information about each article 14. The shipping information may comprise one or more of destination, priority (i.e., urgency, for example as determined by a shipping company), special instructions (e.g., special care which may be required by a delicate article, option to unbundle a compound article, etc.), etc. Accordingly, it may comprise one or more handheld scanners, or be configured to interface with them to receive information therefrom. The handheld scanner may be configured to image and/or interpret a marking on the article 14 presented in machine readable form. The marking may comprise one or more of alphanumeric characters and/or a barcode (such as a one-dimensional or two-dimensional barcode).

According to some examples, the registration station 12 may be configured to identify shipping information encoded within a computer-detectable signal, for example transmitted using radio-frequency identification, or any other suitable manner Accordingly, it may be configured to interface with a suitable scanner.

According to some examples, a scanner (not illustrated) is provided, for example mounted on the dimensioning frame 28, configured to image the marking autonomously, for example during measurement of the dimensions of the article 14. The system 10 may be configured to provide a backup procedure, wherein it alerts an operator that no shipping information was detected autonomously (e.g., no marking was detected, or no signal was detected, as the case may be), so that an operator may manually identify it, e.g., with a suitable handheld scanner.

The registration station 12 may further comprise a computer terminal 34, which may be configured to facilitate input by an operator and/or to present information thereto. The input may include, but is not limited to, information related to the article, such as special instructions, notes regarding observed physical damage of an article upon or prior to registration, etc. In addition, it may be used to interface with a handheld scanner, for example as described above with reference to identification of shipping information. Information presented may include, but is not limited to, acknowledgement of registration, summary of properties identified, instructions, etc.

The computer terminal 34 may be further configured to estimate the center of gravity of a registered article 14 and/or compound article.

The registration station 12 may further comprise a camera (not illustrated) configured to image the article 14, for example for visual-verification purposes by an operator.

The weight sensor 24 and/or linear dimensioning arrangement 26 may be configured to communicate information with the computer terminal 34. Accordingly, the computer terminal 34 may be configured to collect/correlate freight data about each article 14, identified by the registration station 12, and communicate it to the controller 18. The freight data may comprise the physical attributes and shipping information of each article 14.

As mentioned above, the build-up station 16 is configured for packing articles onto cargo units prior to being loaded onto cargo vehicles. Accordingly, it is typically the located in close proximity and/or with convenient access to areas within the site with arrangements (e.g., conveyor belts or similar arrangement, dedicated roadways, loading docks, etc.) for transporting cargo units to the cargo vehicles.

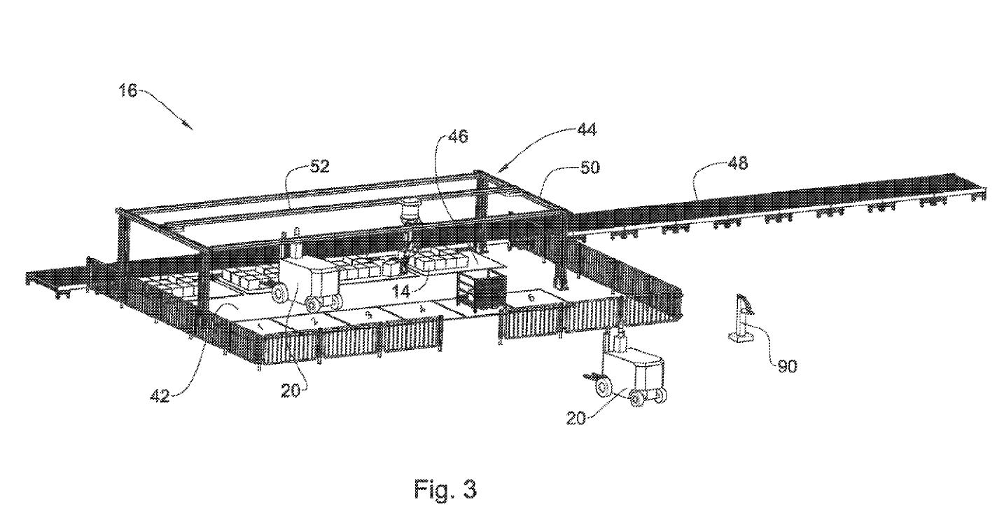

As illustrated in FIG. 3, the build-up station 16 comprises a safety barrier 40 defining therewithin a packing area 42, and a packing rig, generally indicated at 44, disposed so as to operate within the packing area to pack articles onto cargo units. Cargo zones 46 may be defined within the packing area 42, either virtually (i.e., by the processor 18 relating thusly to selected areas within the packing area) and/or by physical demarcation (e.g., with markings disposed on selected areas within the packing area). As mentioned above, the build-up station 16 may be arranged adjacent a conveyor arrangement 48.

The packing area 42 may comprise multiple cargo zones 46, facilitating packing of several cargo units simultaneously by a single packing rig 44.

The packing rig 44 may be provided as a gantry crane, comprising a frame 50 supporting one or more packing mechanisms, one of which is illustrated and generally indicated at 52.

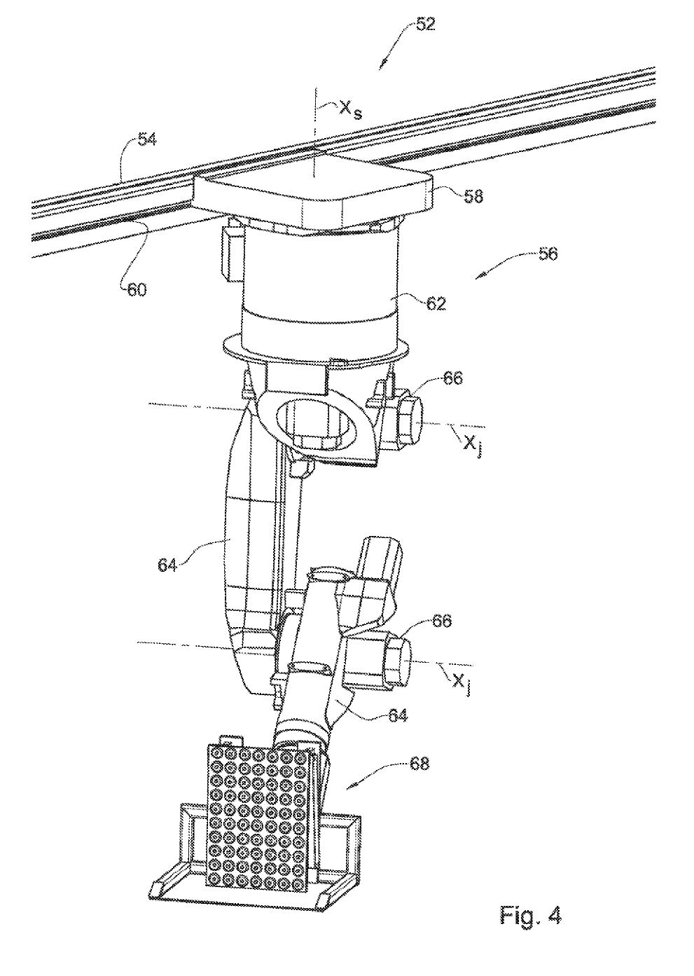

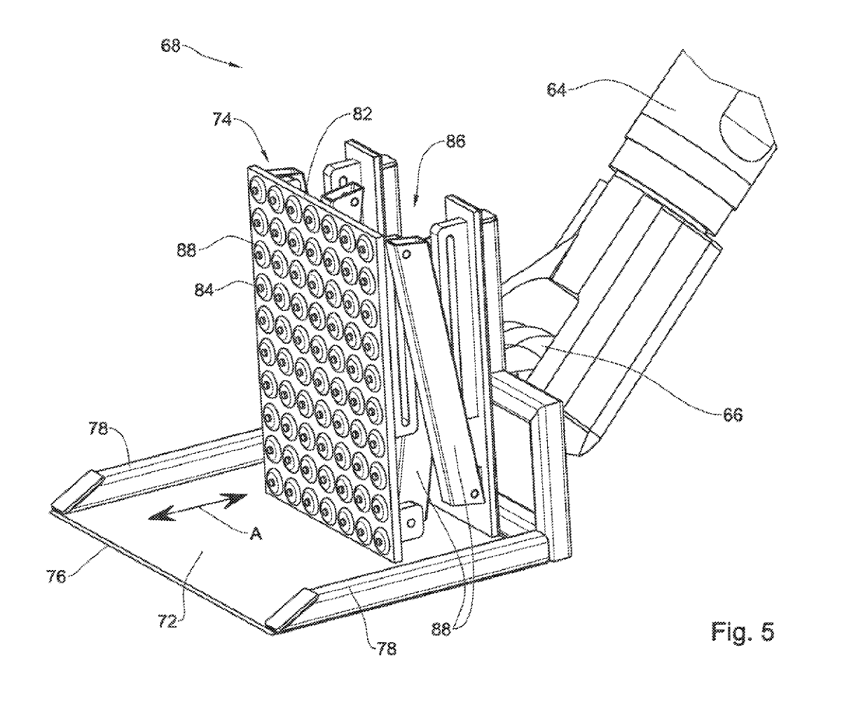

As better seen in FIG. 4, the packing mechanism 52 comprises a longitudinally extending track 54 supporting a robotic arm 56, which is configured to move longitudinally therealong. The cargo zones 46 are selected so as to be accessible by the robotic arm 56 for arrangement of articles 14 thereon.

The packing mechanism 52 is configured for facilitating packing the cargo units by picking up articles and placing them in a predetermined location, for example as determined by the controller 18, as will be described below. It may be further configured to operate autonomously, e.g., under direction of the controller 18.

The robotic arm 56 comprises a carrying arrangement 58, which is configured to bear the robotic arm on the track 54, and to facilitate linear actuation thereof longitudinally along its length. Accordingly, the track 54 and carrying arrangement 58 are co-configured for the actuation. For example, the track 54 may comprise one or more longitudinal grooves 60, with the carrying arrangement 58 comprising a suitably designed mating arrangement configured to be received therewithin. The carrying arrangement 58 may comprise an actuating mechanism to drive it (and thereby the robotic arm 56) along the length of the track. Alternatively, the track 54 may comprise an actuating mechanism which moves along its length, and is designed to mate with at least a portion of the carrying arrangement 58 to tow it as it moves along the length of the track.

The robotic arm 56 further comprises a swivel base 62, several links 64 pivotally articulated to one another about joints 66, and a grip 68 configured to retain an article thereon while being moved by the robotic arm. The swivel base 62 is rotatably articulated to the carrying arrangement 58, and comprises a motor, such as a stepper motor, and/or other suitable mechanism therein (not seen) to selectively rotate it, and thereby the rest of the robotic arm 56 therebelow, about a swivel axis Xₛ. Each of the joints 66 is configured to facilitate pivoting of adjacent elements (i.e., the swivel base 62, links 64, and a connecting rod 70 of the grip 68) of the robotic arm 56, with respect to each other. Each of the joints 66 comprises a motor, such as a stepper motor, and/or other suitable mechanism therein (not seen) to selectively rotate the elements it connects about each other, each about axis Xⱼ. The controller 18 coordinates the operation of the swivel base 62, the joints 66, and the actuating mechanism of the track 54/carrying arrangement 58 to manage the position of the grip 68.

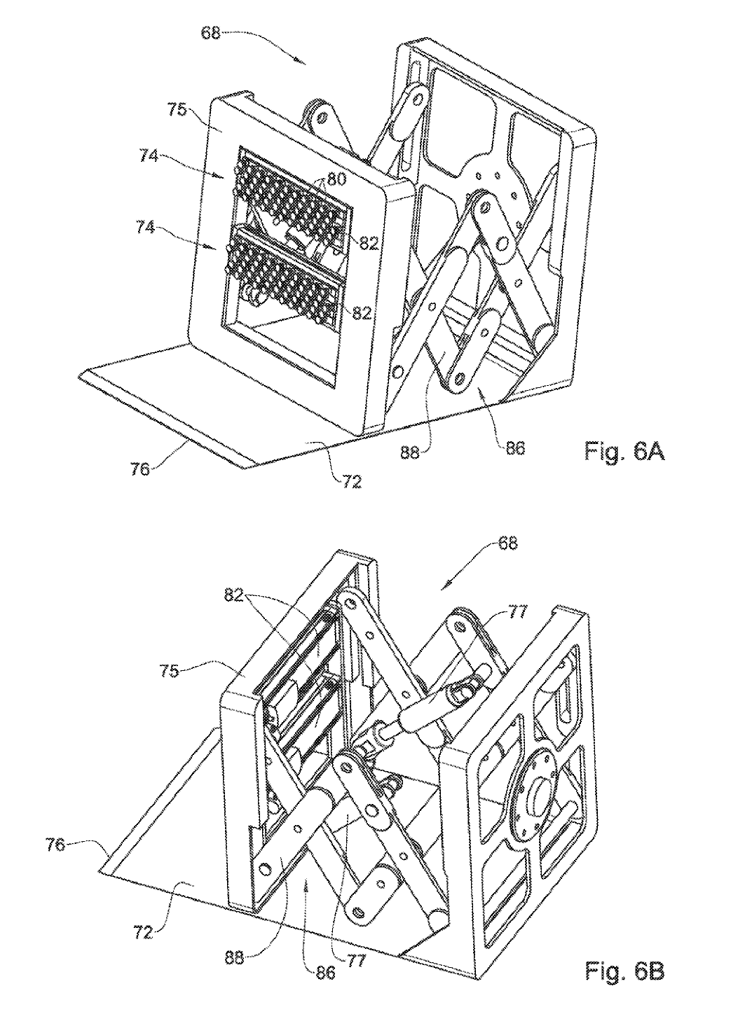

As mentioned, the grip 68 is configured to retain an article thereon as it is moved be the robotic arm 56, for example onto a cargo unit. Accordingly, as seen best in FIGS. 5 through 6B, it comprises a support platform 72 constituting a surface for supporting an article from below, and one or more vacuum arrays 74 disposed substantially perpendicularly thereto in a vertical position, and optionally retained within a face plate 75 (for example as illustrated in FIGS. 6A and 6B).

The support platform 72 may comprise a thin, e.g., tapered, leading edge 76, which facilitates sliding of the support platform under an article. Raised guiderails 78 (seen only in FIG. 5) may be provided on side edges of the support platform 72, extending at least partially between the leading edge 76 and the vacuum array 74.

The support platform 72 may further comprise an arrangement (not illustrated) configured to facilitate sliding of the article thereupon. According to some examples, the arrangement comprises a plurality of freely-rotating rollers. The rollers may be, e.g., linear rollers disposed parallel to the vacuum array, an array of plurality of spherical rollers, or any other suitable arrangement. The upper surface of the support platform 72, or a majority thereof, may be constituted by the rollers, facilitating movement of articles thereupon. According to other examples, the upper surface of the support platform 72 may be provided with a low-friction coating, for example made of a polytetrafluoroethylene material, such as is sold by DuPont Co. under the trade name Teflon™. It will be appreciated that the two examples are not mutually exclusive, e.g., the support platform 72 may be provided such that some areas thereof are constituted by the rollers, and some are covered with a low-friction coating.

Each of the vacuum arrays 74 comprises a plurality of nozzles 80, e.g., individually controlled, mounted on a panel 82. According to some examples, each of the nozzles may be configured to be selectively activated to impart a negative pressure at an opening 84 thereof. According to other examples, all of the nozzles 80 on each of the panels 82 are configured to be so activated together. According to further examples, all of the nozzles 80 of the grip are configured to be so activated together. Accordingly, a suitable negative pressure source is provided, along with an arrangement for connecting each of the nozzles thereto (not illustrated). The negative pressure facilitates maintaining the article against the vacuum array 74, thereby facilitating it to “grip” the article, thereby maintaining its position on the support platform 72.

Each of the vacuum arrays 74 may be further configured to pivot, e.g., independently of one another. The pivoting may be controlled or free. Additionally, for example according to the example described above with reference to and illustrated in FIGS. 6A and 6B, the vacuum arrays 74 may be configured to move vertically (i.e., perpendicularly with respect to the support platform 72), either together or independently. Accordingly, one or more suitable linear actuators (not illustrated) may be provided for this purpose. Either of these features may be useful for lifting, e.g., slightly, of the article, for example to facilitate movement thereof onto the support platform 72 and/or therealong.

Each of the nozzles 80 may comprise a sensor and a corresponding valve (both not illustrated). The sensor, which may be a pressure sensor or any other suitable sensor, is configured to detect the presence of the article abutting thereagainst. Upon detection of the article by the sensor, its corresponding valve is opened to apply a negative pressure to the article. Thus, only the nozzles in contact with the article are activated, maximizing the negative pressure applied thereto. Each of the nozzles 80 may further comprise one or more sensors configured to detect reduced performance requiring maintenance, for example by detecting pressure loss, etc.

The vacuum array 74 may be connected to a linear actuator (e.g., according to the example described above with reference to and illustrated in FIG. 5, this may refer to the panel 82 being directly connected to a linear actuator, while according to the example described above with reference to and illustrated in FIGS. 6A and 6B, this may refer to the panels being connected thereto indirectly via mounting of the face plate 75 on the linear actuators) configured to selectively move it over and longitudinally along the length of the support platform 72, as indicated by arrow A. According to one example, it comprises a scissors mechanism 86 comprising a plurality of folding supports 88 linked together in a criss-cross pattern. According to another example (for example as best seen in FIG. 6B), the linear actuator may comprise one or more controllable pistons 77. According to a further example (not illustrated), the linear actuator comprises a mechanism actuated by a lead screw.

In use, the robotic arm 56 is operated by the controller 18 to pick up an article utilizing the grip 68. For example, it may be configured to pick up an article (i.e., bring it onto the support platform 72) by maneuvering the grip 68 to a location adjacent an article with the vacuum array 74 fully extended, e.g., such that it or the openings 84 of the nozzles 80 are above the leading edge 76 of the support platform. As it advances toward the article, valves are selectively opened (e.g., based on detection by the sensors, as described above), whereby the vacuum array 74 “grips” the article. As the linear actuator 86 is operated to retract the vacuum array 74, the article is pulled onto the support platform.

The robot arm 56 may be operated by the controller 18 in a reverse manner to deposit an article in a predetermined location.

According to some examples, the processor 18 may be configured to estimate the position of an article on the support platform 72, at least partially based on the identification of sensors which detect the presence of the article. The processor 18 may thus be configured to use this information as input in a feedback loop during packing to adjust operation of the robotic arm 56.

According to other examples, each of the nozzles 76 is mounted on an extension arrangement (not illustrated), configured to maintain the nozzle at a distance perpendicular from the panel 82. Each extension arrangement is configured to buckle under force, and to return to its extended position when the force is removed. Such an arrangement facilitates “gripping” of irregularly-shaped articles, e.g., wherein a surface thereof abutting the vacuum array 74 is not planar.

It will be appreciated that while examples of the grip 68 have been described above with respect to and illustrated in FIGS. 5 through 6B, a grip according to the presently disclosed subject matter may include combinations of features, each of which is disclosed with respect to only one of the examples, without departing from the scope of the presently disclosed subject matter, mutatis mutandis.

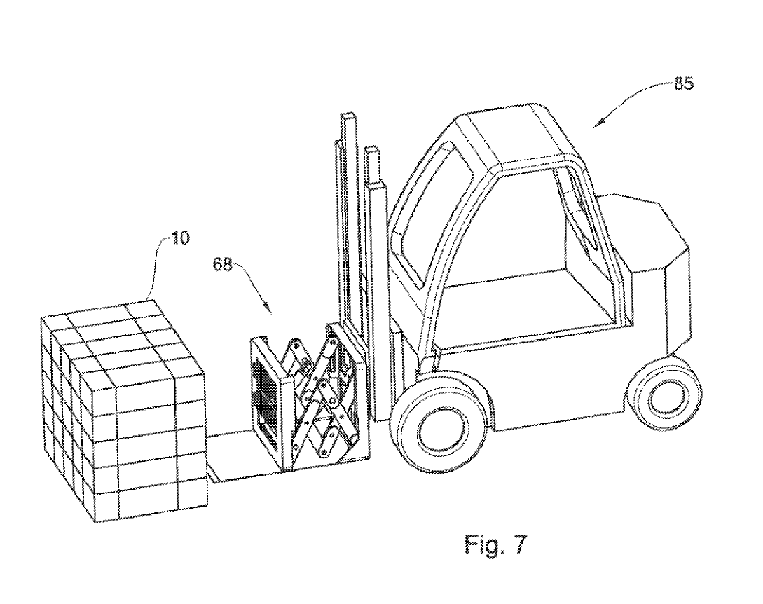

It will be further appreciated that while the robotic arm 56 has been described with reference to, and constituting a part of, a system for management of packing articles on cargo units to be loaded on cargo vehicles, it may be provided as a stand-alone apparatus, as part of a different type of system, etc., wherein the term “article” as used to refer to any item or items which is retained by and moved thereby, without departing from the scope of the presently disclosed subject matter, mutatis mutandis. Similarly, the grip 68 may be provided as a standalone apparatus, as part of a different type of system (for example, a lift truck 85 similar to a forklift, as illustrated in FIG. 7 with an article 14 to be moved thereby, wherein the fork thereof is replaced by the grip 68 described above with reference to FIGS. 5 through 6B; while the lift truck is illustrated comprising a grip similar to that illustrated in FIGS. 6A and 6B, it may comprise any grip as described above), etc., without departing from the scope of the presently disclosed subject matter, mutatis mutandis.

A robot arm 56 as described above with reference to and illustrate in FIGS. 4 through 6B may be utilized to access articles which are stored close to a ceiling with little clearance therebetween, for example at the top of a stack of articles. The use of a vacuum array facilitates retrieving such articles, or placing articles in such a position, as little space is necessary to lift the article.

In addition, the robot arm 56 may be used to lift articles without the need for a pallet therebeneath. It may also grip articles irrespective of their geometry and/or weight distribution, i.e., it may grip an article without regard for its geometric center and/or its center of gravity.

It may further be used to selectively grip several articles, for example utilizing selective activation of nozzles 80, e.g., as described above.

Reverting to FIG. 3, the build-up station 16 may further comprise a computer terminal 90, which may be configured to facilitate input by an operator and/or to present information thereto. It may be configured to communicate with the packing rig 44, e.g., to provide instructions thereto, receive feedback therefrom, etc.

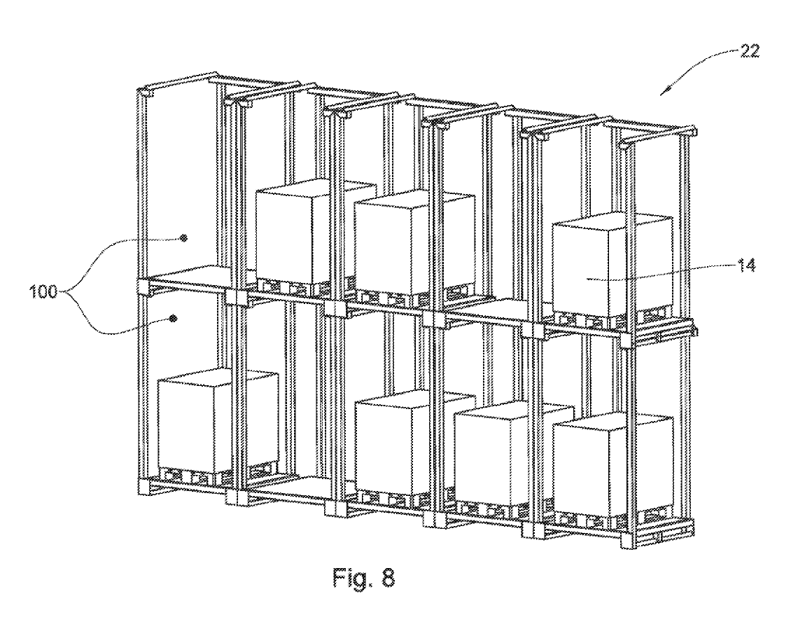

As mentioned above, the storage facilities 22 are provided for storage of articles between their registration and packing thereof onto cargo units, as described above. This may be useful, e.g., wherein articles arriving at the site for shipment on cargo vehicles which are not loaded immediately. Storage in the storage facilities 22 may thus facilitate efficient administration of the site. As illustrated in FIG. 8, each of the storage facilities 22 comprises a plurality of compartments 100, which may be designed and/or arranged in any suitable configuration, for example as determined by a site administrator. (For clarity, a storage facility 22 comprising six compartments 100 is illustrated in FIG. 8. It will be appreciated that, in practice, storage facilities 22 typically comprise a large number of such compartments, arranged in many rows.)

For example, multiple compartments 100 may be stacked above one another, compartments may be provided having different dimensions (height, width, depth) and/or weight capacities, etc. Each of the compartments 100 may be identified, e.g., with a human-readable label and/or a machine-readable label/computer-detectable signal.

As mentioned above, the controller 18 is configured to direct operation of the system 10, including all elements thereof. In addition, it is configured to manage the packing of articles on the cargo units, including, but not limited to, optimizing the arrangement of articles on each cargo unit (arrangement of articles within a cargo unit refers to the position of the articles within the cargo unit, and may further include orientation of at least some of them), optimizing a schedule for carrying out a plurality of packings (e.g., for loading on a plurality of cargo vehicles) at a single site, optimizing storage of articles the storage facilities 22 according to an intermediate arrangement, etc. It is further configured to update some or all aspects of the packing, including, but not limited to, those listed above, when an article is newly registered. Accordingly, the controller 18 is configured to issue instructions to implement the management.

The instructions may relate to one or more of at least the following:
transporting one or more registered articles from a registration station 12 to a storage facility 22 for storage according to the intermediate arrangement;
transporting all registered articles associated with one or more cargo units, e.g., those to be loaded onto the same cargo vehicle, to one of the build-up stations 16; and
packing one or more of the cargo units according to the arrangement determined by the optimization performed by the controller 18 (the controller 18 may determine that some articles, e.g., those of a high weight, are to be packed by one or more of the autonomous vehicles, while other articles, e.g., those below a predetermined weight, are to be packed by the robotic arm 56, while still others are to be packed by a human, and issue instructions accordingly).

Each of the instructions comprises commands suitable to direct an appropriate agent or agents (such as an autonomous guided vehicle 20, the robotic arm 56/packing rig 44, and/or a human operator) to carry it out. Some or all of the instructions may be provided in more than one format, for example a first set provided as commands for the robotic arm 56, and a second set provided as human-readable for a human operator to verify operation of the robotic arm.

According to any of the examples, the human-readable instructions may be in printed/printable form, or presented on an electronic screen. They may comprise text-based instructions and/or graphically-presented instructions.

The instructions may be detailed, for example including commands necessary to direct the robotic arm 56 to move an article to its predetermined location in the arrangement in the cargo unit, or general, for example including commands to the computer terminal 90 of the build-up station 16 regarding placement of an article, with the computer terminal left to process the command and issue its own detailed commands to the robotic arm 56 to implement the controller's 18 general instructions.

The controller 18 may further provide instructions in view of safety considerations. For example, the commands may be provided so as to ensure that no more than one autonomous vehicle 20 is located within the packing area 42 at a time. Alternatively, it may relate to different areas of the packing area 42 separately, and insure that only one autonomous vehicle 20 operates within each area at a time (as in FIG. 3, the controller 18 may direct one autonomous vehicle 20 to deposit articles 14 in the packing area, and direct a second autonomous vehicle to pick up the deposited articles for packing, with the areas that the autonomous vehicles operate being separated by the location that the articles are placed).

The controller 18 may have access to information regarding the cargo vehicles. This information may include, but is not limited to, destination, flight schedule, and combinations of cargo unit types which may be loaded thereupon. The combinations of cargo unit types which may be loaded on a particular vehicle depend on the physical constraints of the cargo vehicle, but other factors may also be considered.

Herein, reference to a combination of cargo unit types which may be loaded onto a cargo vehicle refers to a group of cargo units that, when loaded onto the vehicle, does not permit loading of any other cargo units of the types under consideration. For example, the size and layout of a cargo vehicle may permit loading of 6 pallets thereon, 5 pallets and 2 containers, or 4 pallets and 4 containers. Each of the above would be considered a combination, as only pallets and containers are under consideration, for example as determined by a site administrator.

Further, reference herein to a subset of a combination of cargo unit types refers to groups of cargo unit types, the number of each of which does not exceed that defined by the combination. For example (continuing that given above), a groups of 4 pallets and 2 containers is a subset of the combination defining 5 pallets and 2 containers, since the number pallets in the subset does not exceed the number of pallets in the combination, and the number containers in the subset does not exceed the number of containers in the combination). For the purposes of this disclosure, each combination is a subset of itself. Although some groups may be subsets of more than one combination for a given cargo vehicle, for purposes of this disclosure, it will be referred to as a subset of a combination.

In operation, the controller 18 is configured to receive freight data about each article communicated by the registration station. From this data, it may use the physical attributes and shipping information for further optimizations. In addition, it may use the shipping information to associate each article with a target cargo vehicle.

Based on the freight data of all of the articles assigned to one cargo vehicle, the controller 18 is configured to carry out an optimization to determine an the arrangement of articles on each cargo unit to be loaded on the cargo vehicle. The optimization uses as inputs the physical attributes of each article, the dimensional capacity of each cargo unit, and the weight capacity of each cargo unit. It may also use operation constraints, for example as provided by a site administrator, as inputs. Operational constraints may include, but are not limited to, custom loading rules, load priority, maximum height of cargo units (such as pallets), direction of loading, etc.

The controller 18, e.g., at least partially based on the arrangement and/or as part of the determination thereof, selects a shipping group which is to be loaded onto the target vehicle. The shipping group is the group of cargo units to be loaded on the target cargo vehicle, and is shipping group is a subset of one of the combinations of cargo units which may be loaded thereon for transport.

The controller 18 provides, as output from the optimization, layout plans for the each of the cargo units, the total weight of each one, and an approximate center of gravity for each cargo unit once loaded (it will be appreciated that as the center of gravity for each article is not necessarily known, the exact center of gravity of a cargo unit packed according to the arrangement determined by the controller 18 can only be approximated, but not known exactly). The controller 18 may further determine, as part of the optimization, a layout of the cargo units on the cargo vehicle, for example to optimize their weight distribution once loaded. The optimization of the layout plans for each cargo unit, including assignment of each article to a cargo unit within the shipping group, may consider the layout of the cargo units on the cargo vehicle as feedback, thereby modifying the layout plans of the articles in order to optimize the layout of the cargo units on the cargo vehicle.

The controller 18 may be configured to determine, e.g., simultaneously with determining the optimized arrangement of articles, an optimized intermediate arrangement of articles, each associated with a plurality of cargo vehicles, within compartments 100 of the storage facility 22. The intermediate arrangement is determined/optimized by the controller 18 to facilitate efficient management of the storage facility 22. Such efficient management may be directed toward minimizing the amount of time necessary for removal of articles therefrom for transport to a build-up station 16. In determining the intermediate arrangement, the controller 18 may use as inputs the target cargo vehicle for each article, as well as a time schedule relating to the loading of each one(determined, for example, based on departure schedule of various cargo vehicles, time necessary to pack the cargo units for each one, etc.). For example, an article which is to be loaded earlier than another article may occupy the same compartment in the storage facility 22, but be located closer to an opening thereof. Thus, in optimizing the intermediate arrangement, the controller 18 takes into account how removal of an article affects and/or is affected by removal of other articles.

In performing any of the optimizations, the controller 18 may consider a compound article as a single article, and perform the optimization based on its aggregate properties. Alternatively, the controller 18 may consider the constituent articles thereof, for example if their individual properties are known or can be determined (e.g., multiple identical constituent articles arranged in regular rows/columns/stacks), and perform the optimization based thereupon. The controller 18 may further decide whether a compound article should be unbundled for packing. The decision may be based on any one or more relevant factors, for example shipping instructions, time required to unbundle, gains (e.g., in optimization) which may be realized by unbundling, etc.

It will be appreciated that while reference to transporting to the storage facility, storage therein, transporting to the build-up station 16, packing, etc., is made to articles, the controller 18 may instruct that several articles be bundled together, for example after registration thereof, and transported and/or packed together. It will be further appreciated that the controller 18 may instruct articles to be bundled together at one stage (e.g., after registration), and unbundled at a later point (e.g., before packing), for example to facilitate transporting/storing a large number of articles in an efficient manner

The controller 18 may determine to “close” registration of articles for a cargo vehicle. According to one example, the closing of registration for a cargo vehicle is based on the scheduled departure of a cargo vehicle (e.g., a predetermined amount of time therebefore, optionally taking into account a projected packing time). According to another example, the closing of registration for a cargo vehicle is based on a determination that the arrangement of articles cannot be further optimized to accommodate any more articles than already registered.

Once the controller “closes” registration for a cargo vehicle, it may issue instructions to begin the packing, e.g., transporting articles from the storage facility 22 to the build-up station 16, etc.

The controller 18 may be configured, upon registration of an article suited, e.g., based on its destination, for a cargo vehicle with a “closed” registration, to re-optimize the arrangement of articles within the shipping group to accommodate the newly-registered article therein. In making this determination, the controller 18 takes the current state of packing into account. For example, if the re-optimized arrangement does not affect the placement of articles already packed, the controller 18 may determine that it may be implemented in place of the previously optimized layout, and issue instructions to transport the article directly to the appropriate build-up station 16. The controller 18 may further determine that the time required to remove already-packed articles from a cargo unit is small enough to justify doing so in order to implement the newly-optimized layout.

According to some examples, the controller may be further configured to select a target cargo vehicle, based on the articles to be loaded thereon. Accordingly, it may be configured to define a shipment group, which comprises a plurality of articles which are to be loaded onto the same cargo vehicle. This may be determined, e.g., based on any suitable information and/or requirements, including, but not limited to, flight schedules and/or destinations, shipping requirements, safety requirements, etc. The controller may be configured to select a suitable cargo vehicle from a predetermined list of available vehicles, for performing the optimization described above. In addition, the controller may be configured to optimize selection of the cargo vehicle selected as part of the optimization described above.

It will be appreciated that the controller 18 is configured to perform multi-objective optimization, for example determining an optimized arrangement of articles as well as intermediate arrangement, the solutions to each of which may affect one another. Methods for solving such optimization problems are well-known. They may be solved, for example, using classical methods, such as weighted sum, ϵ-constraint, weighted metric, Benson's method, and value function method. They may also be solved using evolutionary approaches for multi-objective optimization solving. Descriptions of some suitable methods are described, e.g., in “Multi-Objective Optimization using Evolutionary Algorithms” by Kalyanmoy Deb, published by John Wiley & Sons, 2001.

Those skilled in the art to which this invention pertains will readily appreciate that numerous changes, variations and modifications can be made without departing from the scope of the invention mutatis mutandis.

1. A system for management of packing articles on one or more cargo units, each of the one or more cargo units for loading on one of a plurality of cargo vehicles, the system comprising:
a registration station to identify and communicate freight data characterizing each of said articles, thereby facilitating registration thereof, wherein said freight data includes physical attributes and shipping information, and wherein said registration station includes one or more computer-controlled sensors to identify at least some of said physical attributes;
a build-up station configured for packing said articles on said one or more cargo units, said build-up station including a robotic arm configured for carrying one or more of said articles; and
a controller to receive said freight data from the registration station, and to direct operation of the system;
wherein said controller is configured to perform a packing optimization including:
associating each registered article with a target cargo vehicle, based at least on said shipping information;
determining an optimized arrangement of articles, based at least on said physical attributes thereof, assigned to a single target cargo vehicle, within said one or more cargo units;
determining an arrangement of cargo units on said cargo vehicle, wherein the weight distribution of said units is optimized; and
determining, based on the associated target cargo vehicle associated with each registered article, an optimized intermediate arrangement for storage, between registration of articles and packing thereof on said cargo unit, of a plurality of articles associated with different cargo vehicles, wherein the determination of said intermediate arrangement is optimized to increase the efficiency of removal therefrom of articles associated with a single cargo vehicle;
wherein said controller is configured, subsequent to the determining the optimized arrangement of articles assigned to a single target cargo vehicle, to determine a re-optimized arrangement of articles assigned to the target cargo vehicle upon association of a new article to the target vehicle.

2. The system according to claim 1, each of said plurality of cargo vehicles defining a finite number of combinations of cargo unit types for loading thereupon, said packing optimization including selecting a shipping group for loading on said target cargo vehicle, said shipping group including said one or more cargo units being a subset of one of said combinations.

3. The system according to claim 2, wherein the selection of a shipping group is at least partially based on the optimized arrangement of articles.

4. The system according to claim 2, wherein said controller is configured to issue instructions related to transporting all registered articles associated with at least one cargo unit of a shipping group to a predetermined location for the packing.

5. The system according to claim 1, wherein the controller is further configured, when determining the re-optimized arrangement of articles, to consider the current state of packing of articles into said one or more cargo units.

6. The system according to claim 5, said controller being configured to consider time required to remove one or more articles from said one or more cargo units when determining said re-optimized arrangement.

7. The system according to claim 1, wherein said controller is configured to issue instructions related to one or more of:
transporting one or more registered articles for storage according to said intermediate arrangement; or packing one or more cargo units of a shipping group according to the optimized arrangement.

8. The system according to claim 1, wherein said controller is configured to consider, in performing said packing optimization, at least some of:
physical attributes of each article;
shipping information of each article;
dimensional capacity of each cargo unit; or weight capacity of each cargo unit.

9. The system according to claim 8, wherein said controller is further configured to consider, in performing said packing optimization, operational constraints.

10. The system according to claim 1, wherein said controller is configured to determine an optimized arrangement of cargo units, packed as per the optimized arrangement of articles, on the cargo vehicle.

11. The system according to claim 10, wherein said controller is configured to simultaneously determine said optimized arrangement of articles within each cargo unit and said optimized arrangement of said one or more cargo units on the cargo vehicle.

12. The system according to claim 1, being configured to register a compound article being characterized by aggregate freight data and including a plurality of articles bundled together, each being independently characterized by individual freight data, wherein said controller is configured to selectively perform the packing optimization based on one of said aggregate and individual freight data.

13. The system according to claim 1, wherein said computer-controlled sensors includes a linear motion scanner system.

14. The system according to claim 1, wherein said computer-controlled sensors comprises a weight sensor.

15. The system according to claim 1, wherein said registration station is configured to identify said shipping information encoded within a computer-detectable signal.

16. The system according to claim 1, wherein said registration station is configured to identify said shipping information presented on said article in machine-readable form.

17. The system according to claim 1, wherein said controller is further configured to determine an approximate center of gravity of each cargo unit.

18. The system according to claim 1, said packing optimization further comprising defining a shipment group of registered articles for associating with the same target cargo vehicle, and selecting, from a predetermined list of available vehicles, a target cargo vehicle for being associated with the registered articles of said shipment group.

19. The system according to claim 18, said controller being configured to simultaneously select a target vehicle, determine an optimized arrangement of cargo units thereon, and determine a optimized arrangement of articles within each of said one or more cargo units.
